(19) United States
(12) Patent Application Publication
(10) Pub. No.: US 2009/0265217 A1
(43) Pub. Date: Oct. 22, 2009

(54) SYSTEM FOR TRIGGERING TERMINALS

(75) Inventor: Hans-Peter Aurenz, Nurtingen (DE)

Correspondence Address: FISH & RICHARDSON P.C., PO BOX 1022, MINNEAPOLIS, MN, 55440-1022, US

(73) Assignee: AJAMES GMBH, Stuttgart (DE)

(21) Appl. No.: 12/297,035

(22) PCT Filed: Apr. 13, 2007
(86) PCT No.: PCT/EP2007/003288

§ 371 Date: Jan. 23, 2009

(30) Foreign Application Priority Data
Apr. 13, 2006 (DE) 10 2006 018 245.6

(51) Int. Cl. G06Q 10/00; G05B 19/042; H04L 9/32; G08B 21/00; G10L 17/00

(52) U.S. Cl. 705/10; 700/7; 713/168; 340/540; 704/246; 700/21

(57) ABSTRACT

A method and a system are proposed, wherein all the terminals of a physical unit and a control appliance are connected to a physically separate control center via a base terminal appliance. This control center has the base terminal appliances of further physical units connected to it. In addition, the control center has producers connected to it which manufacture the terminals or supply services for the terminals or types of terminals. To actuate the terminals, provision is made for selection processes which are input on the control appliance to be conveyed via the control center to the producers of the appliances, from where the control signals produced there are supplied via the control center to the relevant terminals. There is thus no direct connection made between a type of remote control and the appliance controlled by it.

The invention relates to a system for the actuation and/or control of actuatable terminals.

Most entertainment appliances in households today have a remote control facility, that is to say can be actuated and controlled using remote controls. This is usually done using infrared connections. When there are several appliances, it is sometimes necessary to use a dedicated remote control for each appliance.

Universal remote controls have also already become known which can be used to control various appliances. In this case, however, it is not always entirely a simple manner to set them for the different appliances.

Two-way remote control between audiovisual appliances and a remote control is already known in which the audiovisual appliance shows its status information on a screen on the remote control. The user can then see and select the title of a CD, for example, on this screen. In this case, it is also already known that this information provided by the audiovisual appliance can be taken as a basis for using the Internet to check what further details there are for this title (U.S. Pat. No. 6,255,961).

In addition, remote control for a plurality of audiovisual appliances is known which can use the Internet to obtain information and control commands for various types of appliances and manufacturers from an appliance database, and also elements from graphical user interfaces which can be shown on the remote control. This connection to the database of manufacturers can be made at regular intervals, for example whenever the appliance is put down. The control commands and graphical user interfaces which are then ascertained are stored in the remote control unit (WO 03/100553).

In addition, a system for the remote control of consumer electronics domestic components and for the management of media contents is known (DE 10310746). In this context, the domestic components and the communication appliance are provided with a respective dedicated interface for Internet access. The commands are routed via the Internet to a central server and from this via the Internet back to the domestic component. The server knows the contents of the commands.

It is likewise known practice to link electrical appliances to a local area network and to activate these appliances from the Internet. In this case, no data interchange is possible, however, since the appliances cannot access the Internet from the local area network (WO 99/65192). Service providers can load software onto a service server.

The invention is based on the object of providing a way of always having the most up-to-date facilities available for servicing, actuation and control of actuatable terminals. It is therefore always intended to be possible to react to processes on the terminals instantaneously.

To achieve this object, the invention proposes a system having the features cited in claim 1. Developments of the invention are the subject matter of subclaims.

The system proposed by the invention firstly includes the terminals, that is to say at least one terminal. This needs to have the facility to be actuated via an interface. This ought to be the case with most appliances, since the remote control facility using infrared control which is already in place today requires that the appliance have an interface.

The terminal is connected by means of its interface to the base terminal appliance, which for its part is connected to a control center outside the area which contains the terminals. The base terminal appliance also has the input device connected to it which a user uses to input information. This information is sent via the base terminal appliance to the control center and is interpreted as instructions. On the basis of this information, the control center uses the base terminal appliance to supply either control signals to the terminal or control signals and information signals to the indicator device. The input device, whose visible action corresponds approximately to remote control to date, therefore does not address the terminals. The terminals are addressed by the control center arranged outside the local unit.

The status information supplied by the terminals via the interface is also not supplied directly to the indicator device, but rather via the base terminal appliance to the control center, where it can be processed or edited.

On the basis of these measures, it is possible for the control commands to take account of instantaneous currently prevailing circumstances. Furthermore, it is possible for the input device to be of simple design, since it merely operates as a terminal.

It may make sense and is proposed by the invention for the input device and the indicator device to be combined in one appliance, what is known as a control unit. In practice, this control unit then has exactly the same appearance as a remote control to date. However, it is likewise possible for the input device to be separated from the indicator device, or else for an input device to be used which addresses a control unit which nevertheless has an input device.

In one development of the invention, provision may be made for the base terminal appliance to be in a form such that the information from the control appliance is supplied only to the control center.

The control center, which is located with a service company, for example, may be in a form such that it supplies the control commands to the respective terminal or to the terminals in response to information supplied by the control appliance.

In special situations, however, provision may also be made for the control center to supply control commands independently, for example in emergency situations or if it recognizes that a terminal is possibly damaged, meaning that it is better to switch it off. This could happen in response to status information, for example, which is supplied by the terminal itself, that is to say not by the control appliance.

In one development of the invention, provision may also be made for the control center to supply information to the control appliance. This information may be information which is obtained from status information from the addressed terminal. By way of example, information may be supplied when a control command has been acknowledged by the terminal.

However, it is likewise possible for the control center to take information from the control appliance as a basis for not yet producing a control signal but rather a further information signal which is displayed on the control appliance. This applies to the case in which the information signal from the control appliance provides further options from which it is then also necessary to select.

It has already been mentioned that the actual control commands for the terminals are supplied by the control center, specifically in response to information coming from the control appliance. The control appliance, or in other words the information sent by the control appliance, determines which of the terminals is supplied with the control commands, however. The terminal is therefore not selected in the control center but rather in the control appliance. At the outside, in the event of an emergency, as has already been mentioned above, there may be a way for the control center to disregard information from the control appliance.

To repeat, the control appliance determines which terminal is selected. However, it is the control center which, on the basis of this information signal, for its part determines whether a control command or else a further item of information is actually supplied now. By way of example, it is conceivable for the situation when a user wishes to increase the volume of an appliance to involve the control center not converting this request into a control command but rather indicating to the user of the control appliance that the volume is already very high and should not be increased.

In one development of the invention, provision may be made for the control center to have information stored about the terminals connected to a base terminal appliance in a memory. This information is not the status information which indicates the respective current status of the appliance, but rather the information about the type, the model and the serial number of the terminal. This information normally changes very slowly, which means that it appears to make sense to keep this information in the control center once in a non-temporary memory. Naturally, the status information is also stored provided that it is required for initiating particular processes. This involves temporary storage, however.

It is also possible for the terminals also to constantly submit their appliance information in addition to the status information, however.

It has already been mentioned that the control center is outside the local area which contains the terminals, for example in the case of a service company. Naturally, it then makes sense for the control center to be connected to a multiplicity of base terminal appliances situated in individual units, for example residences, office buildings or the like. The control center is in a form such that it can address and identify the individual base terminal appliances. This can be done by allocating a customer number or by similar methods.

To be able to supply all possible manners, types and models of terminals with control commands instantaneously in each case, one development of the invention may involve the control center being connected to producer units from the producers responsible for each terminal. On the basis of the information which the control center has about the terminals of the base terminal appliances, the control center can ascertain the producer which is responsible for the respective terminal. Producer units are to be understood to mean units in which appliance information from a particular manufacturer or other information from a service company is combined. This is normally implemented in databases.

At this juncture, it is also necessary to say something about the concept of the producer. There are various types of producers. On the one hand, they may naturally be the direct manufacturer of an appliance which provides the control commands for controlling the appliance. However, there are also service producers providing services for this appliance, for example in the case of a television set the various broadcasting stations with their programs. In this example, there may also be a superordinate producer, namely a producer which produces a kind of television journal from which a user then selects the respective program and the station.

In the case of CD players too, there are several types of producers, namely the manufacturer of the appliance, the producer of the piece of music, possibly even the composer.

It is also conceivable for the control center to be connected to producers of general encyclopedias, so that when playing a piece of music from a particular composer it is also possible for a user to obtain information about the composer himself.

The control center is in a form such that it forwards information coming from a particular base terminal appliance to the responsible producer or producers. Which producer is responsible can either be obtained from the status information or else from the information which the control center has about the terminals which are connected to a particular base terminal appliance.

The type of information which the control center forwards to the producers may be dependent on the type of producer.

Each of these producers now supplies the control center with that information or those control commands which it is able to provide for this appliance or for this type of appliance.

The control center supplies this information or these commands to the household and to the indicator device or control appliance available there. If the number of options to be displayed is too large in one specific case, it is also possible to display a kind of search engine which the user can use to select what he wishes to do at that moment. By way of example, it is thus possible to access a television set in several ways, for example using a symbol for a television set or else using a symbol for a television magazine.

The control center may also be in a form such that it supplies control commands and/or information coming from the producer unit and produced there in response to the information transmitted to it to the base terminal unit from which the information came. The producer therefore does not need to be able to know the owner of the base terminal appliance.

In one development of the invention, provision may be made for the base terminal appliance to be in a form such that it sets up the connection to the control center independently and transmits an explicit customer number. That is to say that when a user installs a base terminal appliance for the first time which he has previously purchased or leased, connection to an Internet connection, for example, is followed by independent setup of the connection to the control center, which is then able to address the base terminal appliance and hence possibly also to identify the customer.

To allow the control center to store information about the type of appliances in its storage means, it is conceivable for this information to be input manually. This could also be done by scanning in a bar code marker. However, it makes particular sense if, in one development of the invention, the terminals are in a form such that the status information they transmit is also their manufacturer, their type and possibly also their serial number. This may be a one-off operation, for example upon registration for the first time.

In line with the invention, it is likewise possible for the base terminal appliance to be used to make this delivery of the status information to the control center by the terminals.

In line with the invention, provision may be made for each terminal, the input device, the output device, the control appliance and the base terminal appliance to have an input facility for an encoding key which is used to encrypt the connection between the terminals, the output device, the input device, the control appliance and the base terminal appliance. Such encryption within a residential unit makes sense because, by way of example, wired or else wireless networks always entail the possibility of information being tapped off from outside.

Using this method, it is also possible for said appliances to be able to explicitly identify the associated base terminal appliance.

The terminals and/or the control appliance may be in a form such that each terminal and the control appliance set up the connection to the base terminal appliance independently following input of the encoding key. Since the base terminal appliance may also have an input facility for the encoding key, that is to say may know the encoding key, provision may be made for the base terminal appliance to set up the connection between a terminal and the control center only if the encoding keys match.

An encoding key, once it has been input into an appliance, may remain in the appliance, so that the initialization needs to take place only a single time.

In one development of the invention, provision may be made for the base terminal appliance to have a buffer store which can firstly be used to buffer-store status information from the terminals and can secondly also be used to provide and store relatively large volumes of data, for example, which come from the outside, for example if the connection to the Internet is fairly slow.

In line with the invention, the base terminal appliance can allow emergency operation if the connection to the control center has been interrupted. In this case, the most important control commands may have been stored which are required for emergency operation of the terminals. However, it is then not possible to take account of instantaneous events.

The control programs required for the emergency operation of the terminals are supplied by the respective associated producers and are stored in the base terminal appliance. In this case, appropriate encryption may ensure that a producer can access only its data.

In one development of the invention, the control center and the base terminal appliance may also be connected in encrypted form.

The same applies to the interchange of information and control signals between the control center and the producers.

In this case too, as inside a household, it may be ensured that the control center and the base terminal appliances and the control center and the producers can explicitly identify themselves to one another.

In one development, provision may be made for the information which the control center holds about the terminals of a base terminal appliance to be encrypted on a customer-specific basis.

The information held in the base terminal appliance may also be encrypted on a customer-specific and/or producer-specific basis.

It makes sense if the encoding key is in hardware form, so that the user can provide his appliances with the encoding key in order, with insertion of a stick being the preferred way of providing an appliance with the encoding key, so that this appliance can then subsequently use the base terminal appliance to report to the control center. By way of example, this stick may contain the individual customer number, which can be used to identify the customer or else the household. This makes the identification of a customer independent of the hardware of the base terminal unit.

To be able to take account of the settings and preferences of various users within a local unit, that is to say a residence, for example, the invention may provide for there to be a plurality of person-specific control appliances for a base terminal appliance. Although these can all use the same encoding key, they may differ by additional features which can also be transmitted to the control center.

This is the simplest way for various users within a local unit to be provided with the facility to control an appliance. However, it is also possible, as proposed by one development of the invention, to split a control appliance into a portion which is used only for display, for example, and into a second portion which is used only for input. This could be a microphone, for example, which, under voice control, performs certain input operations which are displayed on a screen. With such a split, it is possible for a plurality of microphones with transmitters to be provided which operate on a person-specific basis. In this case too, it can again be assumed in the simplest case that a plurality of such input appliances, which are now simply called microphones, affect a normal control appliance which thus also has input facilities in the form of keypads or a touchscreen. In this case too, however, one development provides the option of using special indicator appliances which are used only for display, that is to say do not now have a dedicated input facility.

If there are a plurality of such indicator appliances used only for display, it is possible to provide the facility for an indicator appliance to be associated only with one person. The effect achieved by this is that this indicator appliance displays only selection options for the one user. The association itself is naturally made on an input appliance, for example the control appliance too.

Within a local unit in which a plurality of appliances are connected to a base terminal appliance, the communication can advantageously take place wirelessly in order to avoid the laying of cables.

In the case of a wireless network of this kind, one development of the invention may provide for a plurality of receivers to be distributed in the residential unit so as to allow the control appliance to be located. This means that, by way of example, it is possible, without further selection, to switch on or switch off the light in the very room in which the control appliance is currently situated.

In line with the invention, the control center may be in a form such that the information which is supplied by a base terminal appliance is forwarded to the producers without actually identifying the base terminal appliance. This takes account of the end user's desires for confidentiality of the information.

The control appliance may be an appliance which is of similar design to a remote control or to a PDA, that is to say with a small screen and keys or with a touch-sensitive screen. In this case, the indicator is a visual indicator. This can present the information as symbols.

For visually impaired people, however, it is also possible to use an audible indicator as indicator device. By way of example, this could be done such that when the control appliance has been picked up the options are read aloud and the user initiates the selection at a particular time using a key.

It is likewise possible for the indicator device to be an active indicator in which particular symbols are pushed out of a surface.

The input device which is likewise provided on the control appliance can react to pressure, for example, that is to say may be a touch-sensitive screen. It is also possible for individual keys to be provided for controlling a cursor.

It makes particular sense if the input device is voice input. This gives particular value to the invention, since the actual voice recognition can then be effected using the respective most modern methods within the control center.

With an input device using voice, the control center may be in a form such that the voice information could also be taken as a basis for user recognition.

The control appliance naturally also has a manufacturer, which means that when the control appliance is initialized the control center can in this case too inform the associated producer performing the initialization.

In one development of the invention, the control center may be in a form such that it conveys the output from a terminal to one of a plurality of possible other terminals itself. This is geared towards a situation in which the output from an audio appliance is intended to be sent to one of a plurality of loudspeakers which are set up in different rooms, for example. To determine to which of these loudspeakers or loudspeaker pairs the output signal is intended to be sent, it is sometimes not necessary to ask the manufacturers, which means that the control center can convey this information itself.

Once the conveyance has concluded, the data can be transmitted via the base terminal appliance to the control center and from there back via the base terminal appliance to the selected terminal.

In one development of the invention, provision may be made for the data to be transmitted directly from one terminal to another through the conveyance of the control center and/or of the base terminal appliance.

In another development of the invention, provision may be made for the control center to hold standard information for particular standard situations and standard appliances and for it to be able to send said standard information as a menu to a control appliance. In the case of audio reproduction, it is always possible to set volume, balance, treble and bass, for example. In this case, the control center could hold a standard situation without needing to ask the respective producer.

To identify the household, represented by a base terminal appliance, the system may contain a base identification means which has been plugged or inserted into the base terminal appliance, for example. The base identification means may be in a form such that it contains the information required for encrypting the information interchange and for identifying the billing, for example an identification for the control center, an explicit serial number and both parts of an asymmetric key and also the public key from the control center. Advantageously, these data are written to the base identification means by the operator of the control center during production, specifically in such a way that they cannot subsequently be changed again. In addition, there is the assurance that the secret key in the key pair is externally inaccessible. The operator of the control center produces a particular number of base identification means, for example SIM cards, which are recorded in a database. When such a card has been purchased, its serial number is enabled and is coupled to the relevant customer number.

It is likewise possible for the system to contain a person identification means for explicitly identifying a person. For a household, for example, it is possible to provide a base terminal appliance with a base identification means, for example a SIM card. For this household, a person identification means can then be provided which a person purchases from a service provider, for example together with the base terminal appliance. For more than one member of the household, respective individual person identification means can be purchased which have either the same authorization as the first identification means or else graded authorizations.

These identification means are preferably implemented in physical form, for example in the form of a dongle or a SIM card.

In comparable fashion with the base identification means, the person identification means may be in a form such that it contains the information required for encrypting the information interchange and for identifying the billing, for example an identification for the control center, an explicit serial number and both parts of an asymmetric key and also the public key from the control center. These data are advantageously written to the person identification means by the operator of the control center during production, specifically in such a manner that they cannot subsequently be changed again. In addition, there is the assurance in this context that the secret key from the key pair is externally inaccessible. The operator of the control center produces a particular number of person identification means, for example dongles, which are recorded in a database. When such a dongle has been purchased, its serial number is enabled and is coupled to the relevant customer number.

The person identification means can be used to identify the person for whom billing is required when particular services are provided only in return for payment, for example. This allows a subscriber in a system, for example in a hotel or in a public institution, to obtain such services, which are then billed to him directly and not via the hotel.

It is also possible that the physically implemented person identification means is also able to identify the physical unit's base terminal appliance to which the person identification means actually belongs. It is then possible to effect remote control in this manner. When a user uses his dongle to identify himself on an input appliance in a hotel and the appliance then reports to the control center, the latter can establish that the person identification means belongs to a different base terminal appliance from the connection appliance sending the report. The system can then provide the user with the selection of switching to the base terminal appliance in his own household or else controlling the appliances at the location at which he is currently situated. In this way, he can perform certain monitoring operations in his own household, this sometimes being possible even when his household is associated with a different control center from the base terminal appliance which he has just used to register. In this case, the control and information commands can be forwarded from the control center for the current base terminal appliance to the control center for the desired base terminal appliance.

To ascertain whether the person identification means is associated with the base terminal appliance from which it connects to the control center, serial numbers stored in the control center can be used. If the serial number of the person identification means is not stored in this control center, this control center can make a request to other control centers or else a request to a superordinate management center.

It is possible to associate a plurality of person identification means with a base terminal appliance. These may either have the same or else different authorizations.

In one development of the invention, it is proposed that the base identification means and/or the person identification means may be implemented in physical form, for example in the form of a SIM card and/or in the form of a dongle or stick. In this case, the base identification means is preferably arranged in the base terminal appliance permanently.

The person identification means can also be used for first-time enabling of the terminals connected to a base terminal appliance. This is a one-off operation, which means that the person identification means does not remain connected to the terminal.

In particular, a control appliance and/or an input appliance may have a way of being connected to a person identification means, for example a plug connection.

In one development of the invention, provision may be made for the input appliance to be able to be used to submit a rating for each terminal which is connected to the associated base terminal appliance. Since the person submitting a rating can be explicitly identified by means of a signature using a key, it is also possible to check whether a person submits ratings more than once in order to manipulate the rating. The operation of the system may be such that if a rating is repeated then the user is taken to his previous entry, which he can then change, without submitting a new rating as an additional rating.

It is also conceivable, in order to prevent accusations of manipulation, that although a customer is able to submit a plurality of assessments it is noted that multiple statements are involved.

Apart from rating terminals themselves, a customer can naturally also rate producers and other service providers, that is to say including television programs or television magazines, for example.

The rating can proceed as follows. Whenever the user has selected an appliance or information on the input appliance or on the control appliance and now wishes or is able to actuate said appliance, the system provides him with the option of submitting a rating in a form of a selectable item. When the rating item has been selected, the system provides him with rating stages or nodes, including different criteria. These criteria may be dependent on the type of appliance to be assessed and may vary from type to type. By way of example, it is possible to assess the quality, the simplicity of handling, the price-performance ratio, the visual appearance etc.

It is conceivable that the assessment facilities, including the criteria, will be provided by the producer of the appliance. However, it appears to make sense for the rating criteria and the rating nodes to be provided by another location. This may be the control center itself, for example, or else a kind of consumer center which works out criteria for different types of appliances. This rating relates not only to appliances but also to services which have something to do with such appliances in the vaguest sense.

Since this kind of rating can be carried out using the available system, all the other options mentioned here are available, including encryption of the rating and anonymity toward the location at which the rating is stored and possibly processed.

All the customers for such a system naturally have read access to all the other ratings, possibly even just to an evaluation of the ratings as a whole.

The method proposed by the invention involves a terminal within a unit, for example a residential unit, identifying itself to a control center through the mediation of a base terminal appliance. The control center forwards the identification to the producer of the terminal. The producer produces a display on a control appliance through the mediation of the control center and of the base terminal appliance, and a user selects one appliance from this display. This selection information is conveyed to the producer of the selected terminal again via the control center, so that the producer can produce a control signal for this appliance, which said producer then sends directly to the terminal, bypassing the control appliance, again through the mediation of the control center.

For this method, the terminal which is to be actuated and/or to be controlled and the input appliance do not need to be present at the same location.

In one development of the invention, provision may be made for the location of the terminal and/or the person of the user wishing to actuate the terminal to be identified only to the control center. The control center does not forward this information to the possible producers for the terminal.

Conversely, provision may be made for the content of the information and/or instructions coming from the user to be forwarded by the control center only to the respective producer, while the control center itself does not know the content of this information.

In one development, provision may be made for the information about the terminals which are present at a location to remain stored at the control center, so that the terminals do not have to identify themselves again each time.

In one development of the invention, provision may be made for an input on the input device or on the control appliance to be followed first of all by ascertainment of the location of the terminal which is to be actuated, for example via a base terminal appliance, and then identification of the terminal which is to be actuated.

For the purpose of identifying the location of the terminal which is to be actuated, an identification for a base terminal appliance may first of all be evaluated, subsequently also followed by an identification for a person identification means, however.

If it is established that the local association between the person identification means and the local identification means does not match, remote control of the terminal can take place at the location with which the person identification means is associated. This may either be a location which is associated with the same control center or a location which is associated with a different control center. In this case, the information is forwarded from the first control center to the second control center and vice versa.

The invention likewise proposes a method having the features of claims 77 and 78, which is carried out particularly using a system as has been described herein. For these methods, it is possible to use all the features described herein, particularly methods for encryption, for explicit identification and for retaining anonymity.

The method as defined in claim 77 involves not just rating the terminals which are present in a household. It involves being able to rate all the services which concern these terminals. Every terminal has a direct producer or manufacturer. A rating for the terminal is not simply also a rating for the manufacturer of the terminal, since, by way of example, accommodating behavior says something about the manufacturer but not about the terminal. The manufacturer of the terminal can therefore be rated separately from the terminal. For terminals, however, there are also producers of another kind, for example television stations providing a program. This program can also be rated, as can the television stations themselves. If a television station now broadcasts a film, the maker of the film can also be considered to be a producer. A television magazine referring to a large number of television stations and their programs is also a producer of the terminal ‘television set’ in the broader sense.

On the basis of the method, every terminal in a household is identified to a control center. The control center then forwards an identification for the terminal to all the producers which are possible for this terminal. These also include the television magazines in the case of the television set, for example.

It is clear that the producer making a television magazine is interested only in that a television set is involved, and at the outside what programs it can receive via cable or satellite. The type of television set or the serial number of the television set is not of interest here. For this reason, the control center forwards only the type of terminal, for example, to the publisher of a program magazine. By contrast, the actual manufacturer also obtains the details of the appliance. The kind of identification of the appliance to the producer may therefore be dependent on the kind of producer.

Each of these producers now provides the control center with that information or those control commands which it can provide for this appliance or for this kind of appliance.

The control center supplies this information or these commands to the household and to the indicator device or the control appliance which is there. If, in one specific case, the number of options to be displayed is too great then it is also possible to display a kind of search engine which the user can use to select what is wishes to do at that moment. It is thus possible to access a television set in several ways, for example. First, a symbol for a television set could be selected in order to arrive at the program from there by means of a program selection and a station selection. Another option would be to use a television magazine or, to put it better, a program magazine to select a particular program, in which case only after selection of the program is it determined whether this program is loaded and displayed using a currently running television program or using stored data storage media or from the Internet.

At any stage of such display at which rating makes sense, the user can then select a symbol or use some other means to submit a rating for this article.

In the case of the method described in claim 78 too, the initial selection can be made using a search engine or using a hierarchically organized menu. The articles to be assessed may be the same as in the case of the method from claim 77, or else they may be other articles which are not related to a terminal. Article is therefore to be understood to mean not just terminals, producers of terminals or producers of information but in this case also other service providers, for example insurance companies.

All features which are implemented in one embodiment also apply to all other embodiments. Further features, details and advantages of the invention can be found in the claims and in the abstract, both of whose wording is turned, through reference, into the content of the description, the following description of preferred embodiments of the invention and also with reference to the drawing, in which:

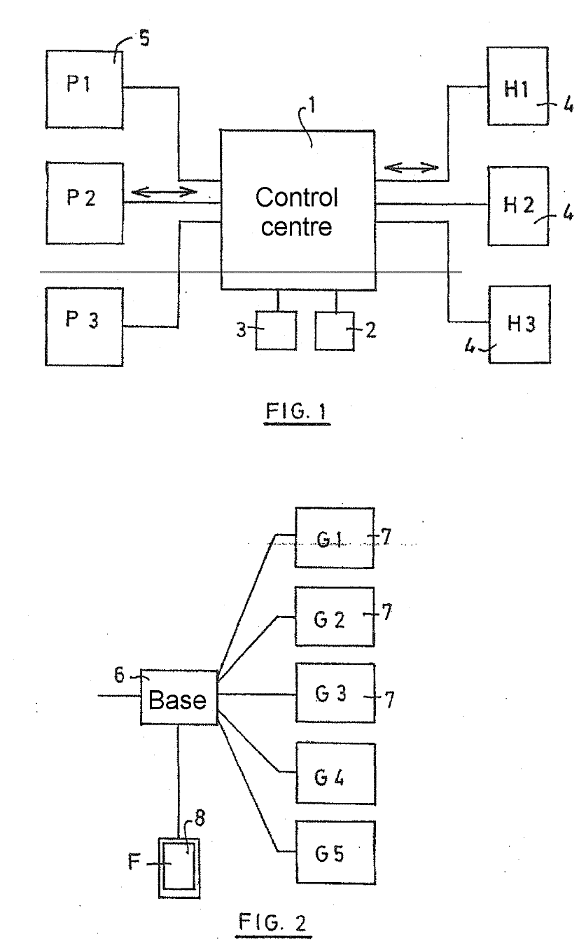

FIG. 1 shows an overview of a system based on the invention;

FIG. 2 shows terminals connected to a base;

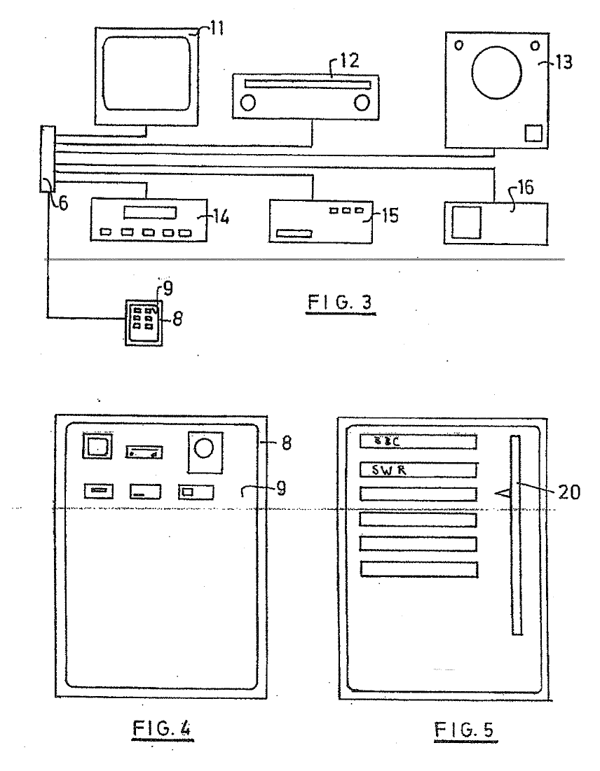

FIG. 3 schematically shows the illustration from FIG. 2 in greater detail;

FIG. 4 shows the view of a control appliance in a first state;

FIG. 5 shows the view of the control appliance in a second state;

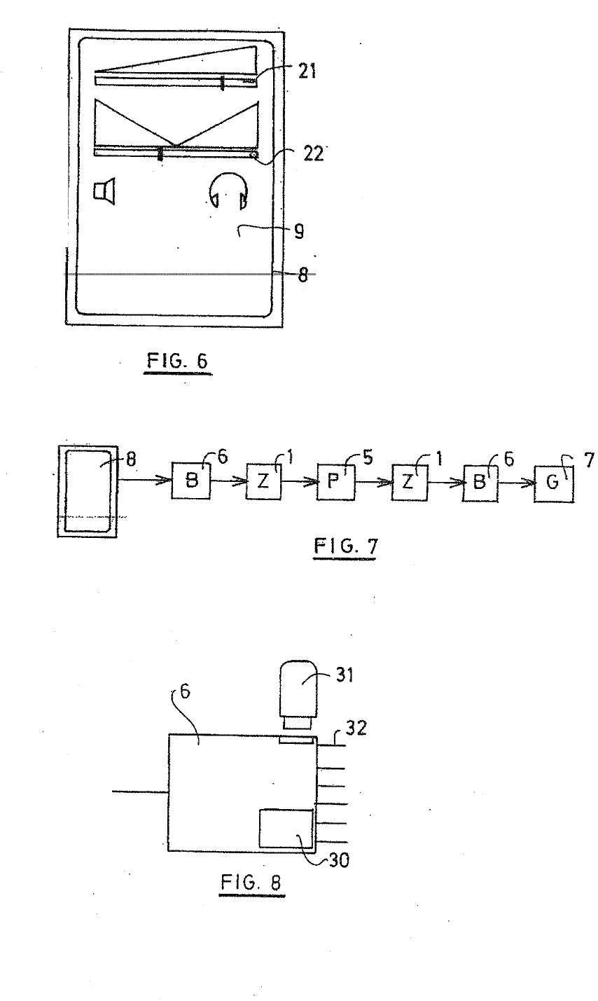

FIG. 6 shows the view of the control appliance in a third state;

FIG. 7 shows a greatly simplified schematic illustration of the flow of control;

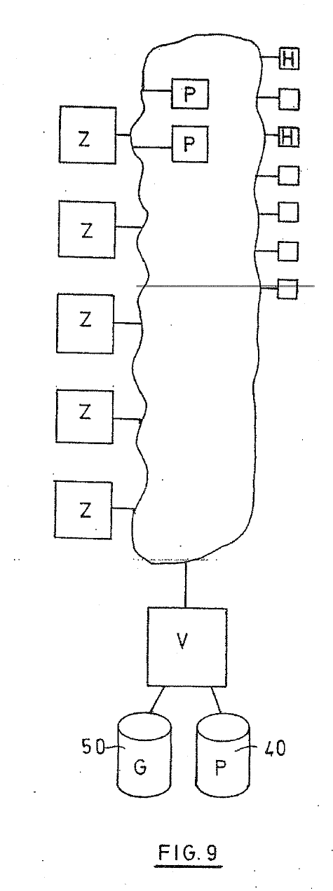

FIG. 8 shows a simplified illustration of a base terminal appliance;

FIG. 9 shows a system comprising a plurality of control centers and a management center;

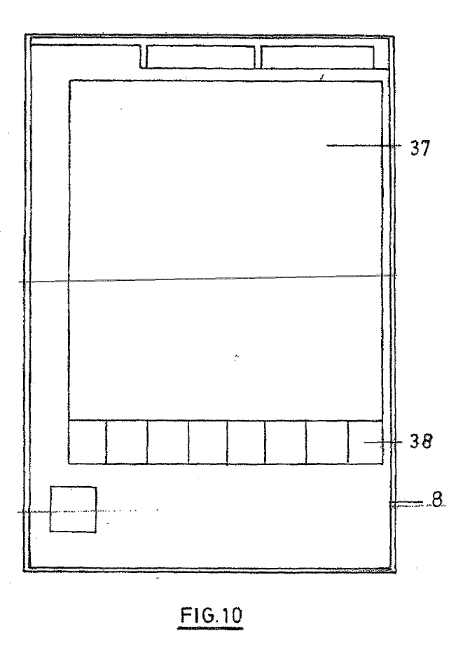

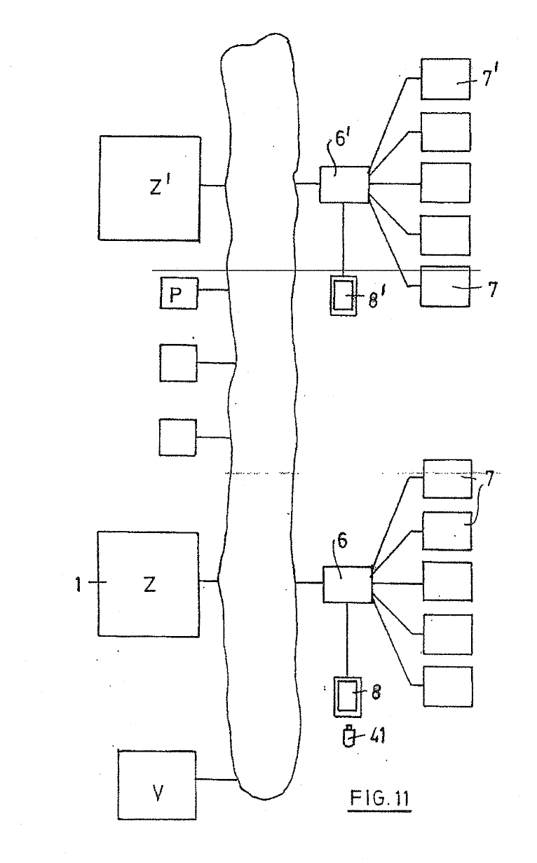

FIG. 10 shows an illustration, corresponding to that in FIG. 6, of an input panel on a control unit;

FIG. 11 shows an illustration which is similar to that in FIG. 9, and

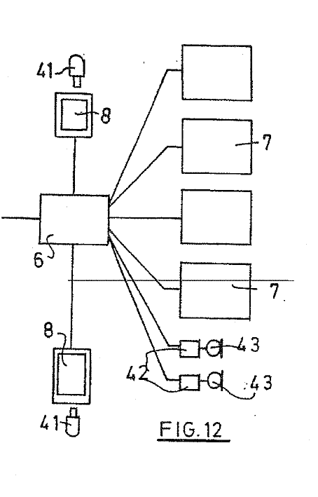

FIG. 12 shows an illustration, corresponding to that in FIG. 2, for a further-developed embodiment.

FIG. 1 shows a schematic overview of the system based on the invention. The central point of the system is a control center 1, which is used as a switching center in a transferred sense. The control center controls databases 2, 3 which contain firstly data from the connected customers and secondly data from the producers or suppliers of appliances or services who are participating in the system. The control center is connected firstly to a multiplicity of units 4, which can be referred to as households. They need not be households, however; they may also be commercial institutions, offices, hotels or the like. The control center 1 is able to identify and address the individual households 4.

On the other side, the control center 1 is connected to a multiplicity of producers 5, the number of producers logically being smaller than the number of households. The control center 1 is also able to individually identify and address the producers 5. The control center 1 firstly knows the households 4 and their appliances, this information being contained in a database 2, for example. Secondly, it knows the producers 5, and the information relating to the producers 5 can be accommodated in a second database 3. The connection between the household 4 on one side and the producers 5 on the other side can be made by the control center 1 itself, this being in such a form that the producers cannot identify the individual household 4.

The control center 1 conveys information and control commands between the households 4 and the producers 5. This conveyance of information can take place such that no information which is not required for this purpose is interchanged. Nevertheless, billing for services can also take place. Information and control commands can be transmitted between the control center 1 and the households 4 in encrypted form, as it can between the control center 1 and the producers 5. The storage of information in the databases 2 and 3 can likewise be encrypted on a person-specific basis.

FIG. 2 shows the design of a household, which is provided with the reference symbol 4 in FIG. 1, in somewhat greater detail. This household or a residential unit contains a base terminal appliance 6 which is connected to the control center 1 via the Internet, in particular. This base terminal appliance 6 sets up the connection between the household and the outside world, so to speak. The residential unit or the household can be identified by means of the base terminal appliance 6 or its serial number or a customer number. This customer number may be held in a supplementary appliance, for example a SIM card or a memory stick.

The base terminal appliance 6 has a plurality of terminals 7 connected to it, the connection being a bidirectional one. In addition, the base terminal appliance 6 has at least one control appliance 8 connected to it, likewise bidirectionally. There is no direct connection between the control appliance 8 and the terminals 7. The base terminal appliance 6 conveys the datastreams between the terminals 7 and the control appliance 8, on the one hand, and the control center 1, on the other hand. From the point of view of the control center 1, the control appliance 8 is a special terminal.

Each of the terminals 7 is provided with an interface which allows the interface to be used to supply control signals to the appliance which execute the functions of the appliance. Furthermore, the interface is suitable for submitting status information, either actively or only when this information is requested. All of this information in both directions is routed to the base terminal appliance 6.

The base terminal appliance 6 is connected to the control center 1, specifically online. As already mentioned, the control center 1 is for its part connected to the producers 5, likewise online.

The control appliance 8 is used to initiate the actuation and/or control of the terminals 7. The actual processing logic for the inputs on the control appliance 8 is not contained in the terminals and in the control appliance 8 themselves, but rather is supplied by the control center 1. However, the control center 1 also does not produce these responses to request signals from the control appliance 8 itself, but rather obtains this information and these control commands from the producers 5. The control center 1 conveys only the requests from the terminal 8 to the responsible manufacturers, and the control commands produced therefrom to the associated base terminal appliance 6 and terminal 7 again.

In the cases in which the request to a manufacturer is not required, the control center can also automatically send information to the control appliance, or else even perform operations. This may be the case when the output of a terminal needs to be connected to one of several other terminals, for example. This mediation can be performed by the control center 1 independently.

FIG. 3 now uses a selected example to show which appliances can be addressed, for example.

The base terminal appliance 6 in the specific household has a television set 11, a tuner 12, a washing machine 13, a video recorder 14, a DVD player 15 and a CD player 16 connected to it. These are thus the terminals for this specific household. In addition, the control appliance 8 is naturally connected to the base terminal appliance 6.

As has already been mentioned, following an original initialization, the control unit 1 knows the appliances which are present in this household. When the control appliance 8 is now started up, the control center 1 prompts the manufacturer of the control appliance 8 to supply to the screen 9 of the control appliance the symbols for the appliances so that they can be shown on the screen 9, said appliances being recorded at the control center 1 for this household. The screen 9 of the control appliance 8 therefore shows the symbols for the terminals in FIG. 3. This is shown on an enlarged scale in FIG. 4. In this illustrated example, it is assumed that the control appliance 8 has a pressure-sensitive screen 9 and no kind of other keys or operating elements. The user of the appliance now needs to select which appliance he now wishes to control or operate. He can do this by touching the symbol associated with the appliance, for example using a stylus or else a finger. It is now assumed that the user wishes to listen to music from the tuner 12, so that he now presses the symbol for the tuner.

On the basis of this information arriving at the control center 1, it is not yet possible to produce a control command for the terminal, since there are other selection options available. The control center 1 sends the selection signal to a location which has stored all the stations which are possible for this appliance. This service provider now supplies a new screen content to the control appliance 8, and said screen content now shows the individual stations, for example as bars, see FIG. 5. Using a scrollbar 20, which the user can move through pressure with the finger, or else through direct pressure on a bar, the user can now select a station and possibly even the program straightaway.

In response to this information signal, the manufacturer of the audio appliance now produces a further screen and supplies it to the screen 9 of the appliance 8. This is shown in FIG. 6. The user can now use a slider 21 (shown at the top end) to set the volume, can use a second indicated slider 22 to set the balance between right and left, and can select whether he wishes to switch on the loudspeaker or a set of headphones.

In the example shown, a three-stage menu is thus provided, and a control command can be sent to the audio appliance 12 as early as the second menu.

In the same way, the user can also select and actuate the other appliances.

FIG. 7 shows the basic operation, as provided by the invention, again in greatly simplified form. Starting from any state of the control appliance 8, an input on the control appliance 8 sends an information signal. This is routed via the base terminal appliance 6 to the control center 1 and from there to the associated producer 5. The producer produces either an information signal or a control command or both in response to the information signal which is being sent to him. This signal is routed from the producer 5 to the control center 1, from there to the base terminal appliance 6 and from there to the terminal 7 and possibly also to the control appliance 8. There is therefore no kind of direct connection between the control appliance 8 and the terminal 7.

The fact that the command chain and the information chain always passes via the control center 1 to the producer 5 and back means that the instantaneous control signals are always produced. In this way, it is possible to respond to certain operations instantaneously. By way of example, this allows interactive television to be implemented. A user can respond to a display on the television set immediately. It is possible to transmit one or more response options to him on the control appliance 8 at the same time as a request on the screen, and he can then select these options.

The direct connection via the control center means that it is also possible for the owners of base terminal appliances to contact one another via the control center. By way of example, it is possible for a voice link and/or a picture link to be set up between the terminals 7 which are in the households 4.

In the example described above, entertainment appliances and a washing machine have been cited as possible terminals. It is entirely conceivable to actuate other appliances within a residence or an office in this way too, for example temperature controls, blackout blinds or curtains, Venetian blinds, heating, doors, alarm systems and computers.

It is also possible to imagine a further breakdown of appliances, so that, by way of example, a tuner or another audio appliance is considered to be a separate unit from the loudspeaker, so that the loudspeaker can be actuated and addressed as a separate appliance. It is also possible to use a screen on a television set as an indicator appliance for a computer, so that the screen is then a separate terminal.

FIG. 8 shows how a base terminal appliance 6 can be designed in greater detail. This base terminal appliance 6 contains a SIM card 30 which a user obtains from the operator of the control center 1. This SIM card 30 contains an identification for the control center 1 so that there is an explicit association between the household in which the base terminal appliance 6 is arranged and the control center 1 which covers this household. Since the connection between the control center 1, that is to say a service provider, for example, and the households is made via the Internet and, of course, a large number of service providers operate using the same communication medium, it is necessary for there to be such an explicit association. This SIM card 30 also contains an explicit serial number and the public and secret parts of an asymmetric key, which is again associated with the household 4. In addition, the SIM card contains the public key from the control center 1. The SIM card has been inserted into the base terminal appliance 6.

The base terminal appliance 6 also contains a plug connection for a dongle 31, which is primarily a method of explicitly identifying a particular person. In addition, the dongle 31, upon being connected to the base terminal appliance 6, takes the public key from the SIM card 30 inserted into the base terminal appliance 6. The dongle 31 identifying the person can thus simultaneously be used to inoculate the individual terminals connected to the base terminal appliance 6 via the indicated connections 32 for the first time, that is to say to transmit the public key from the SIM card 30 inserted into the base terminal appliance 6, so that these are initialized and hence can contact the base terminal appliance 6.

The use of a person identification means in the form of a dongle 31 or of another identifier containing a key pair whose public key explicitly identifies the user makes it possible firstly to perform billing operations on a person-specific basis, for example when there are a plurality of personal identification means 31 within a household. In addition, such person identification makes it possible to use the control appliance 8 to connect such a dongle to a base terminal appliance 6 in another household and there to allow access to one's own household. This means that it is possible to implement remote control or remote maintenance or remote monitoring.

FIG. 9 now schematically shows the arrangement of such a system to a greater extent. Whereas the arrangement shown in simplified form in FIG. 1 and FIG. 2 involves a plurality of households and a control center, this is now a system in which a large number of control centers Z are connected to a large number of households H and a large number of producers P. Naturally, it makes sense for a control center 1 to be connected to a large number of households, with each household normally being connected only to one control center 1 by which it is covered. The indicated producers, which are the manufacturers of the terminals or else suppliers of information for the terminals, are naturally connected to a plurality of control centers, since the control centers wish to provide their households with information for all the appliances arranged in the households.

In this illustrated example, all the control centers are connected to a single management center V which manages license billing operations, for example.

In the case of the exemplary embodiment indicated here, the management center contains a database 40 for people and a database 50 for appliances. It is assumed that, on the basis of a business model, the control centers 1, that is to say the service providers, for example, report a new customer to the management center whenever they gain one. The management center stores information about the customer in a database 40.

Each customer of a control center is therefore recorded in the customer database 40. He is explicitly recorded therein, namely by means of his serial number and/or by means of his public key. Further details about the customer which allow actual identification of the customer on the basis of name and location are not required here.

Every customer of a control center 1 is able to submit a rating for each appliance which is in his household and connected to a base terminal appliance 6 and/or for each producer, particularly the suppliers of information for the appliances. These ratings are recorded in a database 50 to which each customer of a control center has read access. However, each customer can submit a rating only for the appliances which he has, and can also do this only once. If he wishes to submit a rating a second time for the same appliance or for the same supplier of information, this results in his already recorded entry being changed. This ensures that no customer can manipulate the rating through constant input. In addition, it ensures that each customer can only submit ratings for an appliance which he himself is operating.

FIG. 10 again shows, in similar fashion to FIG. 6, the view of a control appliance 8. The control appliance 8 has a series of panels 38 which contain fixed symbols or numbers prescribed by the system. An open panel 37 is provided for unrestricted presentation of respectively new symbols or statements to be selected. This panel is also available to the producers and/or the suppliers of information. They can output screen contents to the panel 37 and can receive commands therefrom.

FIG. 11 is intended to explain an example of a remote control. In the household at the bottom in FIG. 11, which is connected to a control center 1 via a base terminal appliance 6, a user plugs his personal identification means in the form of a dongle 41 into a control appliance 8. The control appliance 8 is able to identify that this dongle 41 is not intended to be used to inoculate it. This is because the control appliance 8 already has a public key. The base terminal appliance 6 is used to address the associated control center 1, which establishes that the owner of the dongle 41 does not match the owner of the base terminal appliance 6. Two cases now need to be distinguished. If the control center 1 has the owner of the dongle 41 registered with it as a customer, it also knows the household with which the owner of the dongle 41 is associated. If it does not have the owner of the dongle 41 registered as a customer, it asks the management center V which control center the person from the identification means 41 is associated with. Once it establishes that such a control center exists, the control center also knows that such a household exists. It does not yet need to know this household, however. In both cases, the user is provided with the option on the input appliance 8 of selecting whether he now wishes to deal with appliances 7 in the household in which he is staying or with appliances 7′ in his home household. If he wishes to address appliances 7′ in the home household, the commands and information are either routed from the control center 1 directly to the relevant household, namely if this household is associated with the control center, or the commands are forwarded to the removed control center associated with the household. From there, the responsible control center undertakes the further editing of the commands and information.

The further information is thus as follows:

→6→Z→V→Z→Z′→P→Z′→6′→7′→6′→Z′→Z→6→8.

If the personal identification means, that is to say the dongle 41, contains the identification of the control center where the owner of the dongle 41 is registered, the request to the management center V is dispensed with. The flow of information is thus somewhat simpler:

8→6→Z→Z′→P→Z′→6′→7′→6′→Z′→Z→6→8

The option of now operating appliances 7′ in one's own, but remote, household from an alien household continues to exist only for as long as this person-related dongle 41 remains in the control unit 8. As soon as the user, that is to say the owner of the dongle 41, removes the dongle, this option is terminated.

However, if the owner of the dongle 41 selects the option not to actuate the appliances 7 in his own but remote household, but rather to actuate the appliances 7 in the household in which he is currently situated, there are several options for how long he can use these appliances. One option is for him to be able to do this also only for as long as his personal identification means 41 is in the control unit 8. The other option is for him to be able to control these appliances only for a particular time, for example when he has rented the household for a particular time for this purpose. A third option is for the actual owner of this household to have to reset the setting again.

We now refer to FIG. 12. FIG. 12 indicates the possibility that a household connected to a control center via a base terminal appliance 6 contains a plurality of control appliances 8. By plugging in a personal identification means 41, the owner of such a person identification means can now make this control unit 8 his own. On the basis of presets, he can now use his control unit to do certain things, while another user can use another control unit 8, likewise identified by his personal identification means, to do only other things. Of course, it makes no sense for two users to be able to control the same appliance at the same time. However, it makes perfect sense for one user to be able to control appliances in one room while the other user can use his control unit 8 to control appliances in another room. In the case of this general consideration, it is assumed that the control units 8 are appliances which have an input facility and an indicator facility, in similar fashion to that indicated in FIG. 6 and FIG. 10.

However, it is likewise possible and is now also indicated with reference to FIG. 12, for the input part of a control appliance to be able to be separated from the indicator part of a control appliance. The input part used would therefore be a separate appliance 42 containing a microphone 43, for example. This microphone 43 can be used to make voice inputs, which are processed in the same way as inputs on a control unit 8, that is to say are sent from the base terminal appliance 6 to the control center and are interpreted there or are forwarded to the producer. The response to such voice control, if it does not directly result in a change for an appliance 7, can then be displayed as information on a control appliance 8 which is present anyway. One development would be that there is a special indicator appliance which does not have the option of input using keys. Even when display and inputs are separated for the control unit, it is possible to set up an association between particular people and a particular indicator unit. Since microphones 43 and the associated electronics can be implemented in much smaller form than an indicator appliance, such a solution is also suitable, by way of example, for being constantly carried by the user within a household. It is then also suitable for locating a specific person, as mentioned at the outset, in order to ascertain which appliances need to be actuated.

Mention has already been made several times of the fact that the flow of information is intended to be encrypted. For the encryption, the following procedure can be used: the party which wishes to send a piece of information creates a symmetric key and a random number control and uses it to encrypt the data which is to be transmitted. Next, it encrypts the symmetric key with the public key from the receiver. It then sends the encrypted data and the encrypted key. The receiver uses its secret key to decrypt the encrypted symmetric key and then the data encrypted therewith. This encryption option has the advantage that symmetric encryption requires little time and that the time-consuming asymmetric encryption relates only to the short symmetric key itself.

A further advantage of this method is that the symmetrically encrypted data can be made available to a plurality of receivers. To this end, the randomly chosen symmetric key is encrypted and transmitted for each receiver with the respective public key.

This kind of encryption can also be used when the producers store their data in the base terminal appliance 6, for example on a hard disk, for a relatively long period.

1-84. (canceled)

85. A system for actuation or control of actuatable terminals, comprising:
at least one terminal which has an interface for receiving control signals and for submitting status information;
at least one input device for inputting information or instructions;
at least one indicator device for displaying information;
at least one base terminal appliance, which is connected to the at least one terminal, to the at least one input device and to the at least one indicator device; and
a control center which is connected to the base appliance, receives information from the base appliance and supplies control signals to the base appliance for forwarding to the at least one terminal;
wherein the control center is operable to individually address and distinguish two or more connected base terminal appliances.

86. The system of claim 85, wherein the base terminal appliance is in a form such that the information or instructions from the input device or from the control appliance is supplied with the exception of an emergency operation only to the control center, wherein the base terminal appliance allows emergency operation and has the control commands required for emergency operation stored which are supplied by the respective associated producers and are stored in the base terminal appliance.

87. The system of claim 85, wherein the control center is connected to producer units from the producers responsible for each terminal, forwards information from the base terminal unit to the responsible producer and wherein the control center supplies control commands or information coming from the producer unit and produced there in response to the information to the base terminal unit and wherein the control center forwards the information to the producers without identifying the base terminal appliances.

88. The system of claim 87, wherein the control center keeps an item of standard control information for standard terminals and is operable to supply the item to the control appliance without checking with the producers.

89. The system of claim 85, wherein the control center is operable to control the conveyance of the output from a terminal to one of a plurality of possible terminals.

90. The system of claim 85, further comprising at least one person identification means for explicitly identifying a person and for storing the keys or key pairs which are required for encrypting information, wherein the person identification means contains: an identification for the control center or an explicit serial number or both parts of an asymmetric key or the public key from the control center, and wherein the person identification means allows identification of the base terminal appliance by the control center.

91. The system of claim 90, further comprising a plurality of person identification means associated with a base terminal appliance.

92. The system of claim 85, wherein information and control signals are interchanged between the control center and the base terminal appliances and between the control center and the producers in encrypted form and wherein the control center, the at least one base terminal appliance and the producers are operable to explicitly identify themselves to one another.

93. The system of claim 85, wherein a plurality of person-specific control appliances are provided for a base terminal appliance.

94. The system of claim 85, further comprising at least one control appliance which comprises the indicator device, the input device and a bidirectional interface.

95. The system of claim 94, wherein the control center supplies control commands to the terminals in response to information supplied by the input device or by the control appliance, is designed to supply information to the indicator device or to the control appliance in response to information supplied by the input device or by the control appliance, and wherein the information supplied by the input device or by the control appliance determines which terminal is actuated.

96. The system of claim 94, wherein the control center responds to the information supplied by the input device or by the control appliance by deciding whether a further item of information is supplied to the control appliance or a control signal is supplied to the terminal.

97. The system of claim 94, wherein each terminal, the input device, the output device, the control appliance and the base terminal appliance have an input facility for an encoding key which is used for encrypting the connection between the terminals, the input device, the output device, the control appliance and the base terminal appliance, wherein the encoding key is present in a form implemented or stored in a hardware appliance.

98. The system of claim 94, wherein each terminal, the input device, the output device and the control appliance are operable to explicitly identify the associated base terminal appliance and set up the connection to the base terminal appliance independently following input of the encoding key when the encoding keys match.

99. The system of claim 94, further comprising a plurality of receivers distributed in a residential unit for the purpose of locating the control appliance.

100. The system of claim 94, wherein the control appliance is initialized by the control center and wherein a terminal is initialized by the control center.

101. A method for actuation or control of electronically actuatable terminals using at least one input device comprising:
receiving at a control center identification of a terminal, the identification based on a manufacturer of the terminal and a type descriptor of the terminal;
forwarding the identification of the terminal to a possible producer of the terminal;
receiving actuation or control information or control commands which is possible for the terminal from one or more producers; and
providing the information or control commands obtained from the producers to an indicator device or to the terminal.

102. The method of claim 101, wherein the location of the terminal or the person of the user is identified only to the control center, which does not forward information to the producers of the terminal.

103. The method of claim 101, wherein the content of the information or instructions coming from the input device or from the terminal provided to a respective responsible producer.

104. The method of claim 101, wherein the location of the terminal to be actuated is identified by evaluating an identification for a base terminal appliance that is locally connected to the input device.

105. The method of claim 101, wherein the location of the terminal which is to be actuated is identified by evaluating an identification from a person identification means connected to the at least one input device.

106. The method of claim 105, further comprising:
forwarding the information to another base terminal appliance and back when the location of the terminal which is to be actuated is associated with the other base terminal appliance covered by a same control center from the location of the input device issuing the request; and
forwarding the information from one control center to the other control center and back when the location of the terminal which is to be actuated is associated with a different control center from the location of the input device issuing the requests.

107. The method of claim 101, further comprising:
receiving a selection of a terminal or of a service or of an item of information;
providing to a user a rating facility for the selected terminal or the service or the information on the indicator device;
receiving a user selection; and
storing an assessment, an identification for the assessed article, and an explicit but anonymous identification of the user in response to the user selection.

108. A method for rating electronically actuatable terminals or producers of and for terminals using at least one input device comprising:
receiving identifications for each terminal of a local unit;
forwarding an identification for a first terminal to at least one producer which is possible in connection with the first terminal;
receiving an actuation or control information relevant to the first terminal, control commands or other services to the control center;
providing the articles obtained from the producers to an indicator device;
providing a rating facility for the articles displayed on the indicator device;
receiving a user selection of an assessment; and
storing the assessment, the articles, and an explicit anonymous person identification for the user in a database.

109. A method for rating terminals or producers, comprising:
receiving user identification from a user using a personal identification means;
providing for display the selection of articles which are to be rated to the user on an indicator device;
receiving a user selection of a first article to be assessed by the user using an input device;
providing the user with the rating stages which are possible for the article on the indicator device in response to receiving the user selection;
receiving a user selection of an appropriate rating stage; and
storing an assessment of the article and an explicit anonymous person identification for the user in a database.

110. The method of claim 109, further comprising:
determining that the database includes the assessment of the article; and
providing the user a database entry for changing the assessment when the database includes the assessment.
